(19) United States
(12) Patent Application Publication
(10) Pub. No.: US 2015/0235524 A1
(43) Pub. Date: Aug. 20, 2015

(54) AMUSEMENT MACHINES

(71) Applicant: Andrew Hedley, Hertsfordshire (GB)

(72) Inventor: Andrew Hedley, Hertsfordshire (GB)

(21) Appl. No.: 14/184,458

(22) Filed: Feb. 19, 2014

(51) Int. Cl. G07F 17/32

(52) U.S. Cl. CPC G07F 17/3297

(57) ABSTRACT

The present invention provides a currency-operated (e.g. coin-operated) or credit-operated amusement machine that provides a test of the user's strength, wherein the machine has an elongate bench having a head end and foot end for a user to lie upon and having an upright frame structure at the head end of the bench, the upright frame having a movable cross-bar extending transverse to the bench and which is captively mounted to the upright frame to be able to move a limited distance in a linear, substantially vertical, motion against the action of a return biasing or resistance device (preferably a coil spring or gas spring) and wherein the machine has a force transducer to sense the force applied to the return biasing or resistance means and a display operatively linked to the processor to display a measure of the force applied.

### FIELD OF THE INVENTION

The present invention concerns improvements in and relating to amusement machines for use primarily in public houses, amusement arcades and other indoor public venues to provide a test of the user's physical strength.

### BACKGROUND OF THE INVENTION

Amusement machines for testing a user's physical strength are a traditional feature of funfairs and are a popular challenge for many fair-goers, giving opportunity both for competition against others and testing against personal goals. One of the most familiar historic forms of this is the tall ‘striker’ apparatus having at its base a strike plate to be hit with a hammer and a vertical frame with a scale and marker that rises up the frame, often too a bell at the top. However, machines of this type are far too bulky and dangerous for use in indoor or confined environments.

In the last few decades electro-mechanical machines have been developed that provide a more compact strike test and other machines have been developed to provide a test of strength of a user's hand-grip with the machines being designed for use in amusement arcades. More recently further arcade machines have been developed incorporating force transducers that provide a test of boxing strength by measuring force applied in hitting an anchored ball. However, none of the afore-mentioned existing machines address testing core muscle strength, especially of the upper body including pectoral muscles.

### SUMMARY OF THE INVENTION

According to a first aspect of the present invention there is provided a currency-operated (e.g. coin-operated) or credit-operated amusement machine that provides a test of the user's strength, wherein the machine has an elongate bench having a head end and foot end for a user to lie upon and having an upright frame structure at the head end of the bench, the upright frame having a movable cross-bar extending transverse to the bench and which is captively mounted to the upright frame to be able to move a limited distance in a linear, substantially vertical, motion against the action of a return biasing or resistance device (preferably a coil spring or gas spring) and wherein the machine has a force transducer (pressure sensor, load cell or strain gauge etc.) to sense the force applied to the return biasing or resistance device and a display operatively linked to the processor to display a measure of the force applied.

Preferably the crossbar is held captive at each end in a respective slot in a respective one of a pair of substantially mutually parallel uprights so that the bar may travel up and down within the confines of each slot. Suitably the cross bar is slidingly inserted in place in the frame first by inserting through a slot in one upright and then through a slot in the other upright and is held in place in the slots by a cap, ring, plate ear or flange at or near each end of the crossbar. Preferably the frame has a respective said return biasing or resistance device mounted extending substantially vertically in each of the pair of uprights and whereby return biasing or resistance force is applied substantially evenly to each and of the crossbar.

Preferably the machine has a processor operatively linked to the transducer and to the display and configured to provide a display of the force in recognised metric or imperial measures of weight (e.g. kg or pounds).

This novel bench press amusement machine can be used for resistance training/exercise as well as for amusement strength testing. It may be adapted to allow the user to perform multiple repeat presses against the return biasing or resistance device and may provide a display of the measurement for each of the repeats and/or a total of the number of repeats and/or maximum and/or average value of the repeats.

The machine preferably further has a housing for the upright frame that encases the return biasing or resistance device and force transducer and preferably also the display means. The housing may be shaped to resemble a gym assistant standing at the head of the bench and seemingly holding the bar near each end.

Preferably the machine further has a respective casing structure at or near each end of the bar that resembles one or more discs or plate weights as used on a bar bell so that the cross-bar with said end casing structures resembles a bar bell and the user's experience in using the machine is both physically and visually reminiscent of pressing a barbell from a bench in a gym.

The display of the machine preferably is located on the upright frame or in the casing substantially centrally of the upright frame above the head end of the bench and facing forwardly towards the user. Preferably a coin or credit token receiving unit is provided on the upright frame or casing of the upright frame also.

### BRIEF DESCRIPTION OF THE DRAWINGS

A preferred embodiment of the invention will now be more particularly described, solely by way of example, with reference to the accompanying drawings in which:

FIG. 1 is a perspective view of the preferred embodiment of the strength test amusement machine with outer casing and padded bench panel in place;

FIG. 2 is a perspective view of the machine with the outer casing and padded bench panel removed to show the support frame for the bench and the upright frame;

FIG. 3 is a close-up perspective view of a side of the machine showing the detail of one of the uprights with its slot and the return biasing or resistance means within;

FIG. 4 is a front view of the amusement machine.

FIG. 5 is a left side view thereof,

FIGS. 6 and 7 are perspective views from the front right, with FIG. 7 showing in closer detail the recess for the user's head while they lie on the bench and showing the preferred location of the hand-operated cross-bar and

FIG. 8 shows the rear of the amusement machine.

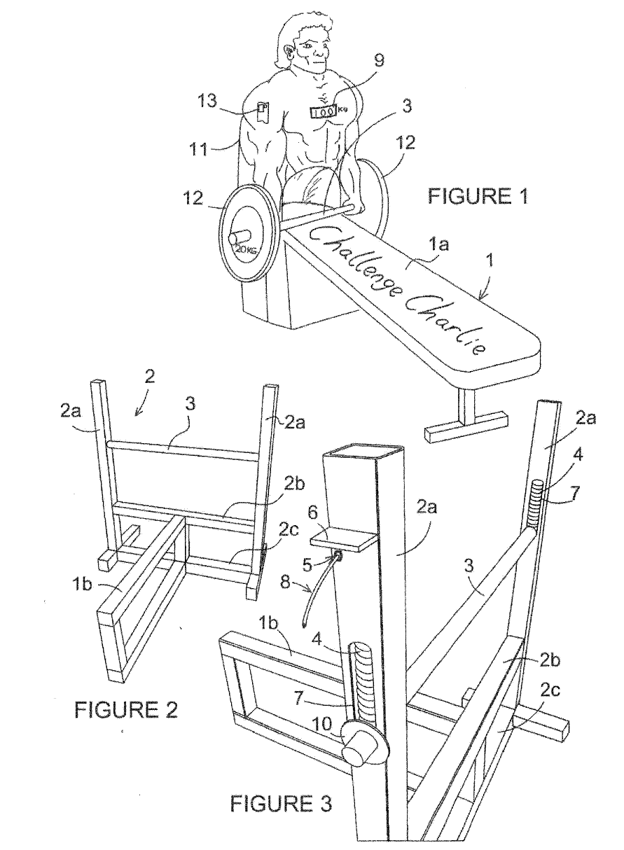

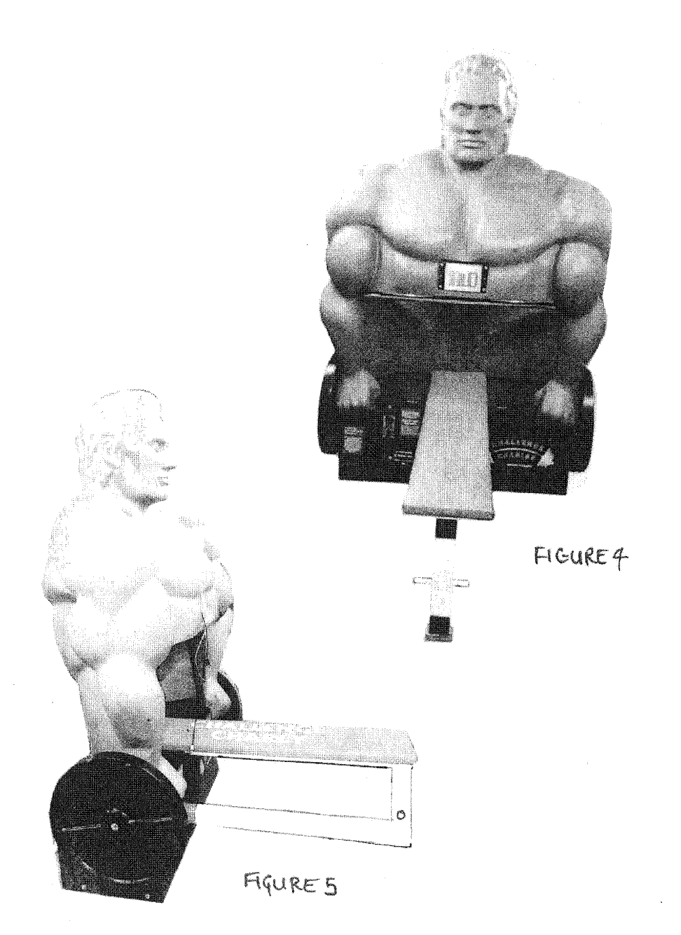

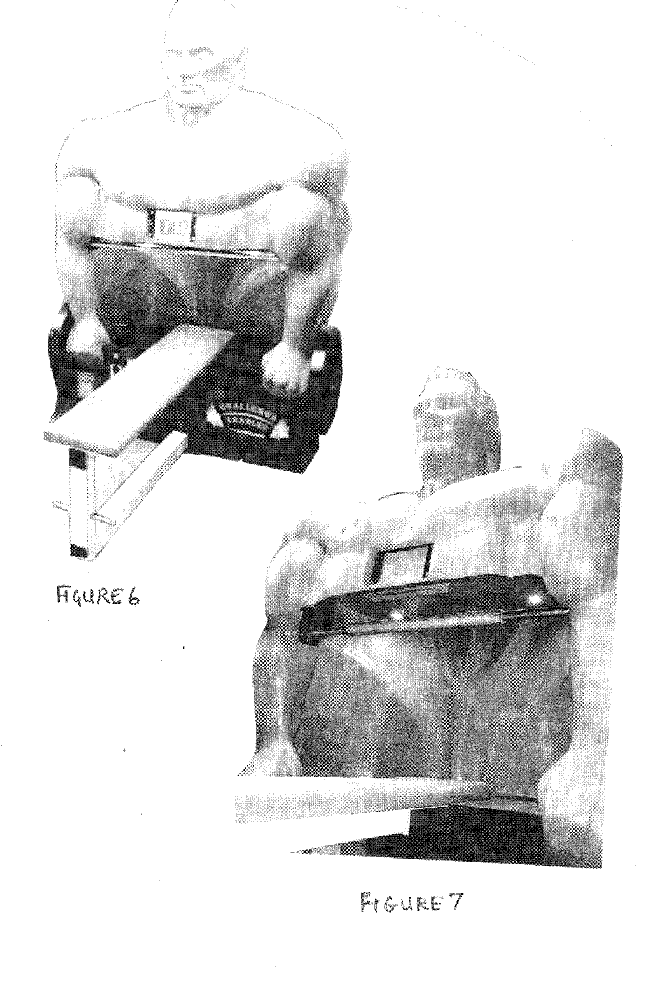

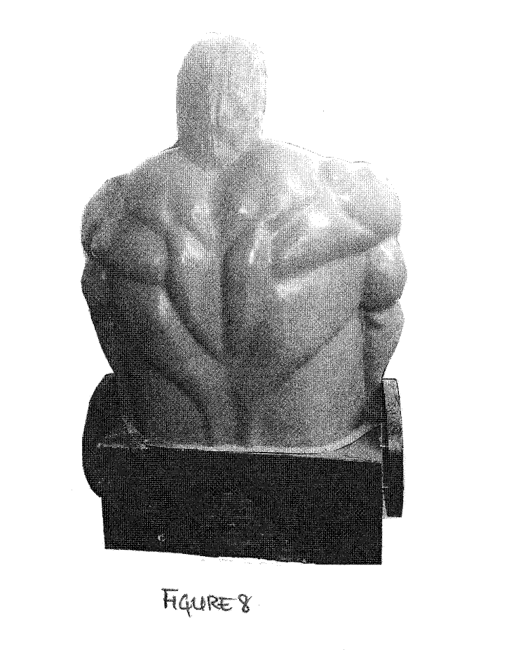

Collectively FIGS. 4 to 8 show the whole of the preferred embodiment, and its ornamentation, as visible in use. The right side of the machine is a mirror image of the left side shown in FIG. 5. The top plan of the apparatus is not generally visible in use and nor is the underside (which has no ornamentation.

### DESCRIPTION OF THE PREFERRED EMBODIMENT

Referring to the Figures, the preferred embodiment of the strength test amusement machine comprises an elongate bench 1 with a padded bench panel 1a on a bench base frame 1b for a user to lie supine upon and having an upright frame structure 2 at the head end of the bench 1.

The upright frame structure 2 has a pair of mutually parallel uprights 2a rigidly connected by upper and lower static/fixed cross bars 2b, 2c. Above these is a movable circular cylindrical cross-bar 3 extending transverse to the bench 1 and which is captively mounted to the upright frame structure 2 to be able to move a limited distance in a linear, substantially vertical, motion against the action of a return biasing or resistance means 4, here illustrated as a compression coil spring.

The movable crossbar 3 is held captive at each end in a respective slot 7 in a respective one of the pair of uprights 2a so that the bar 3 may travel up and down within the confines of each slot 7. When assembling the apparatus, the cross bar 3 is slidingly inserted in place in the frame 1 first by inserting through a slot 8 in one upright 2a and then through a slot 7 in the other upright 2a and is held in place in the slots 7 by a ring plate 10 at or near each end of the crossbar 3. The frame has a respective compression coil spring 4 mounted extending substantially vertically within each of the pair of uprights 2a and whereby return biasing or resistance force is applied substantially evenly to each end of the crossbar. The springs are suitably of the order of 60 mm outside diameter and 300 mm long (uncompressed), each sitting within a box-section tubular upright 2a that has an internal diameter of the order of 70 mm. Each of the springs 4 sits on top of the movable cross bar 3 and is constrained at its upper end by an end stop plate 6 inserted in the upright 2a to hold the spring 4 in place and that the spring 4 abuts and presses against when the crossbar 3 is pressed upwardly by the user.

The machine has a force sensor/transducer 5 such as a pressure sensor/load cell located between the coils of the spring 4 or at one end of the spring 4 adjacent the end stop plate 6 that the spring 4 abuts and presses against to sense the force applied to the spring 4. This is linked by a cable 8 to a processor and alphanumeric or numeric display 9 (suitably LCD or LED) to display a measure of the force applied—e.g. in kilograms. The machine can be used for resistance training/exercise as well as for amusement strength testing. It may be adapted to allow the user to perform multiple repeat bench presses, pressing against the return biasing or resistance means and the processor may provide a display of the measurement for each of the repeats and/or a total of the number of repeats and/or maximum and/or average value of the repeats. The processor may have a memory for the top results achieve and be able to display the user's result ranked against previous users. The machine may also be configured to provide a fanfare or reward or award for high achieving users.

The machine has a housing 11 encasing the upright frame 2 that is shaped to resemble a gym assistant standing at the head of the bench 1 and seemingly holding the movable crossbar 3 near each end. The housing 11 has a window to view the display 9 and also a port 13 for insertion of coins or credit tokens into a payment unit in the machine. A respective casing structure 12 is also provided at each end of the movable crossbar 3 that resembles one or more discs or plate weights as used on a bar bell so that the cross-bar with said end casing structures resembles a bar bell and the user's experience in using the machine is both physically and visually reminiscent of pressing a barbell from a bench in a gym.

The actual extent of travel of the movable crossbar 3 may be miniscule, simply enough to allow the force of pushing of the bar to be measured or, if desired, it may be large and roughly equivalent to the extent of movement when doing conventional bench pressing.

The present invention is described and illustrated by preferred embodiments. Various modifications may be made thereto without departing from the spirit and scope of the invention.

1. A currency-operated or credit-operated amusement machine that provides a test of the user's strength, wherein the machine has an elongate bench having a head end and foot end for a user to lie upon and having an upright frame structure at the head end of the bench, the upright frame having a movable cross-bar extending transverse to the bench and which is captively mounted to the upright frame to be able to move a limited distance in a linear, substantially vertical, motion against the action of a return biasing or resistance device and wherein the machine has a force transducer to sense the force applied to the return biasing or resistance device and a display operatively linked to the processor to display a measure of the force applied.

2. An amusement machine according to claim 1, wherein the crossbar is held captive at each end in a respective slot in a respective one of a pair of substantially mutually parallel uprights so that the bar may travel up and down within the confines of each slot.

3. An amusement machine according to claim 2, wherein the cross bar is slidingly inserted in place in the frame first by inserting through a slot in one upright and then through a slot in the other upright and is held in place in the slots by a cap, ring, plate ear or flange at or near each end of the crossbar.

4. An amusement machine according to claim 2, wherein the frame has a respective said return biasing or resistance device mounted extending substantially vertically within each of the pair of uprights and whereby return biasing or resistance force is applied substantially evenly to each end of the crossbar.

5. An amusement machine according to claim 1, wherein the force sensor/transducer is located within the body of the return biasing or resistance device or at one and thereof adjacent an end stop plate or on the stop plate that the return biasing or resistance means abuts and presses against to sense the applied force.

6. An amusement machine according to claim 1, wherein the return biasing or resistance device is a coil spring.

7. An amusement machine according to claim 1, wherein the machine has a processor operatively linked to the transducer and to the display means and configured to provide a display of the force in metric or imperial measures of weight (e.g. kg or pounds).

8. An amusement machine according to claim 1, wherein the machine further has a housing for the upright frame that encases the frame and the return biasing or resistance device and the force transducer.

9. An amusement machine according to claim 8, wherein the housing is shaped to resemble a gym assistant standing at the head of the bench and seemingly holding the movable cross bar near each end.

10. An amusement machine according to claim 1, wherein the machine has the display of the machine located on the upright frame or in the casing substantially centrally of the upright frame above the head end of the bench and facing forwardly towards the user.

11. An amusement machine according to any preceding claim, wherein a coin or credit token receiving unit is provided on the upright frame or casing of the upright frame.

12. A currency-operated or credit-operated amusement machine that provides a test of the user's strength, wherein the machine has an elongate bench having a head end and foot end for a user to lie upon and having an upright frame structure at the head end of the bench, the upright frame having a movable cross-bar extending transverse to the bench and which is captively mounted to the upright frame to be able to move a limited distance in a linear, substantially vertical, motion against the action of a return biasing or resistance device and wherein the machine has a force transducer to sense the force applied to the return biasing or resistance means and a display operatively linked to the processor to display a measure of the force applied, wherein the machine has a coin or credit token receiving unit provided on the upright frame or casing of the upright frame and the processor has a memory for the top results achieved and is able to display the user's result ranked against previous users or to provide a fanfare or reward or award for high achieving users.
